(19) United States
(12) Patent Application Publication
(10) Pub. No.: US 2026/0019178 A1
(43) Pub. Date: Jan. 15, 2026

(54) TIMING REQUIREMENT FOR CROSS LINK INTERFERENCE REPORTING

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 18/770,499

(22) Filed: Jul. 11, 2024

(51) Int. Cl. H04B 17/309; H04B 7/06; H04W 8/22

(52) U.S. Cl. CPC H04B 17/346; H04B 7/0695; H04W 8/22

(57) ABSTRACT

Methods, systems, and devices for wireless communications are described. Techniques described herein provide for a timing requirement for cross link interference (CLI) reporting. In some examples, a user equipment (UE) may transmit capability information that pertains to a UE capability for CLI measurement and reporting. The UE may receive control signaling that indicates a configuration for the CLI measurement and the CLI reporting based on a timing requirement for the timing between a CLI measurement resource and receipt of a trigger event. The UE may receive control signaling that is the trigger event that triggers the CLI measurement on the CLI measurement resource and that triggers transmission of a CLI report on a CLI report resource. The UE may evaluate a duration between a resource of the trigger event and the CLI report resource to determine participation in a CLI measurement and reporting process.

### FIELD OF TECHNOLOGY

The following relates to wireless communications, including timing requirement for cross link interference reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting, to a network entity, capability information that pertains to a UE capability for cross link interference (CLI) measurement and CLI reporting, where the capability information includes timing information associated with a timing between a CLI measurement resource and receipt of a trigger event that triggers the CLI measurement on the CLI measurement resource, receiving, from the network entity, first control signaling that indicates a configuration for the CLI measurement and the CLI reporting based on the timing information and on a timing requirement for the timing between the CLI measurement resource and receipt of the trigger event, and receiving, from the network entity, second control signaling that is the trigger event that triggers the CLI measurement on the CLI measurement resource and that triggers transmission of a CLI report on a CLI report resource.

A UE for wireless communication is described. The UE may include one or more memories storing processor executable code, and one or more processors coupled with the one or more memories. The one or more processors may individually or collectively be operable to execute the code to cause the UE to transmit, to a network entity, capability information that pertains to a UE capability for cross link interference (CLI) measurement and CLI reporting, where the capability information includes timing information associated with a timing between a CLI measurement resource and receipt of a trigger event that triggers the CLI measurement on the CLI measurement resource, receive, from the network entity, first control signaling that indicates a configuration for the CLI measurement and the CLI reporting based on the timing information and on a timing requirement for the timing between the CLI measurement resource and receipt of the trigger event, and receive, from the network entity, second control signaling that is the trigger event that triggers the CLI measurement on the CLI measurement resource and that triggers transmission of a CLI report on a CLI report resource.

Another UE for wireless communication is described. The UE may include means for transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource, means for receiving, from the network entity, first control signaling that indicates a configuration for the CLI measurement and the CLI reporting based on the timing information and on a timing requirement for the timing between the CLI measurement resource and receipt of the trigger event, and means for receiving, from the network entity, second control signaling that is the trigger event that triggers the CLI measurement on the CLI measurement resource and that triggers transmission of a CLI report on a CLI report resource.

A non-transitory computer-readable medium storing code for wireless communication is described. The code may include instructions executable by one or more processors to transmit, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource, receive, from the network entity, first control signaling that indicates a configuration for the CLI measurement and the CLI reporting based on the timing information and on a timing requirement for the timing between the CLI measurement resource and receipt of the trigger event, and receive, from the network entity, second control signaling that is the trigger event that triggers the CLI measurement on the CLI measurement resource and that triggers transmission of a CLI report on a CLI report resource.

Some examples of the method, user equipment (UEs), and non-transitory computer-readable medium described herein may further include operations, features, means, or instructions for evaluating a duration between a resource of the trigger event and the CLI report resource to determine participation in a CLI measurement and reporting process, where participation in the CLI measurement and reporting process may be based on the duration satisfying the timing requirement based on an offset value, where the offset value may be sufficient to compensate for a forward temporal shifting of the CLI measurement resource.

In some examples of the method, user equipment (UEs), and non-transitory computer-readable medium described herein, the timing requirement may be based on a first quantity of symbols between a symbol of the second control signaling and a symbol of the CLI report resource, a second quantity of symbols between a symbol of the CLI measurement resource and the symbol of the CLI report resource, or both.

Some examples of the method, user equipment (UEs), and non-transitory computer-readable medium described herein may further include operations, features, means, or instructions for evaluating a duration between a resource of the trigger event and the CLI report resource to determine participation in a CLI measurement and reporting process, where participation in the CLI measurement and reporting process may be based on the duration satisfying the first quantity of symbols or the second quantity of symbols and an offset value, where the offset value may be sufficient to compensate for a forward temporal shifting of the CLI measurement resource.

In some examples of the method, user equipment (UEs), and non-transitory computer-readable medium described herein, the timing requirement may be based on a timing advance and the timing advance includes a difference between a downlink reference timing and an uplink reference timing.

In some examples of the method, user equipment (UEs), and non-transitory computer-readable medium described herein, the timing information includes a CLI reporting timing, the CLI reporting timing indicates a quantity of symbols between a symbol of the CLI measurement resource and a symbol of the CLI report resource, the timing requirement may be based on a first quantity of symbols between a symbol of the second control signaling and a symbol of the CLI report resource, a second quantity of symbols between a symbol of the CLI measurement resource and the symbol of the CLI report resource, or both, and the second quantity may be based on the CLI reporting timing.

In some examples of the method, user equipment (UEs), and non-transitory computer-readable medium described herein, the timing information includes a CLI beam switching timing, the CLI beam switching timing indicates a time between a resource of the second control signaling and the CLI measurement resource, the timing requirement may be based on a first quantity of symbols between a symbol of the second control signaling and a symbol of the CLI report resource, or a second quantity of symbols between a symbol of the CLI measurement resource and the symbol of the CLI report resource, or both, and the first quantity may be based on the CLI beam switching timing.

In some examples of the method, user equipment (UEs), and non-transitory computer-readable medium described herein, the second control signaling indicates a triggering offset and the triggering offset indicates the CLI measurement resource that satisfies the timing requirement.

In some examples of the method, user equipment (UEs), and non-transitory computer-readable medium described herein, the triggering offset includes a non-zero value.

In some examples of the method, user equipment (UEs), and non-transitory computer-readable medium described herein, the second control signaling indicates a triggering offset and the triggering offset may be based at least on a first quantity of symbols between a symbol of the second control signaling and a symbol of the CLI report resource, or a second quantity of symbols between a symbol of the CLI measurement resource and the symbol of the CLI report resource, or both, and a timing offset.

Some examples of the method, user equipment (UEs), and non-transitory computer-readable medium described herein may further include operations, features, means, or instructions for evaluating a duration between a resource of the trigger event and the CLI report resource to determine participation in a CLI measurement and reporting process, where participation in the CLI measurement and reporting process may be based on the duration satisfying the timing requirement and refraining from transmitting the CLI report based on the duration not satisfying the timing requirement.

Some examples of the method, user equipment (UEs), and non-transitory computer-readable medium described herein may further include operations, features, means, or instructions for evaluating a duration between a resource of the trigger event and the CLI report resource to determine participation in a CLI measurement and reporting process, where participation in the CLI measurement and reporting process may be based on the duration satisfying the timing requirement and transmitting a partial CLI report based on the duration not satisfying the timing requirement, where the partial CLI report includes a quantity of CLI metrics less than a scheduled quantity of CLI measurements.

Some examples of the method, user equipment (UEs), and non-transitory computer-readable medium described herein may further include operations, features, means, or instructions for evaluating a duration between a resource of the trigger event and the CLI report resource to determine participation in a CLI measurement and reporting process, where participation in the CLI measurement and reporting process may be based on the duration satisfying the timing requirement and transmitting the CLI report including one or more CLI metrics based on the duration satisfying the timing requirement.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a timing requirement for cross link interference (CLI) reporting in accordance with one or more aspects of the present disclosure.

FIG. 2 shows an example of a wireless communications system that supports a timing requirement for CLI reporting in accordance with one or more aspects of the present disclosure.

FIG. 3 shows examples of timing diagrams that support a timing requirement for CLI reporting in accordance with one or more aspects of the present disclosure.

FIG. 4 shows examples of timing diagrams that support a timing requirement for CLI reporting in accordance with one or more aspects of the present disclosure.

FIG. 5 shows an example of a process flow that supports a timing requirement for CLI reporting in accordance with one or more aspects of the present disclosure.

FIGS. 6 and 7 show block diagrams of devices that support a timing requirement for CLI reporting in accordance with one or more aspects of the present disclosure.

FIG. 8 shows a block diagram of a communications manager that supports a timing requirement for CLI reporting in accordance with one or more aspects of the present disclosure.

FIG. 9 shows a diagram of a system including a device that supports a timing requirement for CLI reporting in accordance with one or more aspects of the present disclosure.

FIGS. 10 and 11 show block diagrams of devices that support a timing requirement for CLI reporting in accordance with one or more aspects of the present disclosure.

FIG. 12 shows a block diagram of a communications manager that supports a timing requirement for CLI reporting in accordance with one or more aspects of the present disclosure.

FIG. 13 shows a diagram of a system including a device that supports a timing requirement for CLI reporting in accordance with one or more aspects of the present disclosure.

FIGS. 14 and 15 show flowcharts illustrating methods that support a timing requirement for CLI reporting in accordance with one or more aspects of the present disclosure.

### DETAILED DESCRIPTION

In some wireless communications systems, a user equipment (UE) may be configured to support sub-band full duplex (SBFD) communications between the UE and a network entity. In SBFD communications, the UE may transmit an uplink communication to the network entity and another UE may receive a downlink communication from the network entity using different frequency resources and the same time resource (e.g., SBFD at the network entity). In some examples, the UE may experience interference, such as intra-cell cross link interference (CLI), due to communications by other UEs. As an example, the UE may receive, via a downlink sub-band of an SBFD slot, an uplink signal transmitted by another UE, where the aggressor and victim UEs are in the same cell. To mitigate CLI, the UE may measure and report CLI values to the network entity. However, the UE may not have enough time to be able to perform the CLI measurement and prepare the CLI report for transmission to the network entity.

A UE may have a timing requirement for a timing between a receipt of a trigger event that triggers a CLI measurement on a CLI measurement resource and the CLI measurement resource. Participation in a CLI measurement and reporting process may depend on a scheduled timing between a resource of the trigger event and the CLI measurement resource being greater than or equal to the timing requirement. In some examples, the UE may transmit, to the network entity, capability information that pertains to a UE capability for CLI measurement and CLI reporting. The capability information may be timing information, such as a CLI reporting timing and a CLI beam switching timing. The UE may receive, from the network entity, control signaling that indicates a configuration for the CLI measurement and the CLI reporting. The configuration may be based on the timing information and on a timing requirement for the timing between a CLI measurement resource and a receipt of a trigger event that triggers the CLI measurement. The UE may receive control signaling that is the trigger event that triggers a CLI measurement on the CLI measurement resource and that triggers transmission of a CLI report on a CLI report resource. The UE may evaluate a duration between a resource of the trigger event and the CLI measurement resource to determine participation in a CLI measurement and reporting process. The participation in the CLI measurement and reporting process is based on the duration satisfying the timing requirement. If the duration satisfies the timing requirement, the UE may transmit the CLI report.

Aspects of the disclosure are initially described in the context of wireless communications systems. Aspects of the disclosure are also described in context of timing diagrams and a process flow. Aspects of the disclosure are further illustrated by and described with reference to apparatus diagrams, system diagrams, and flowcharts that relate to a timing requirement for CLI reporting.

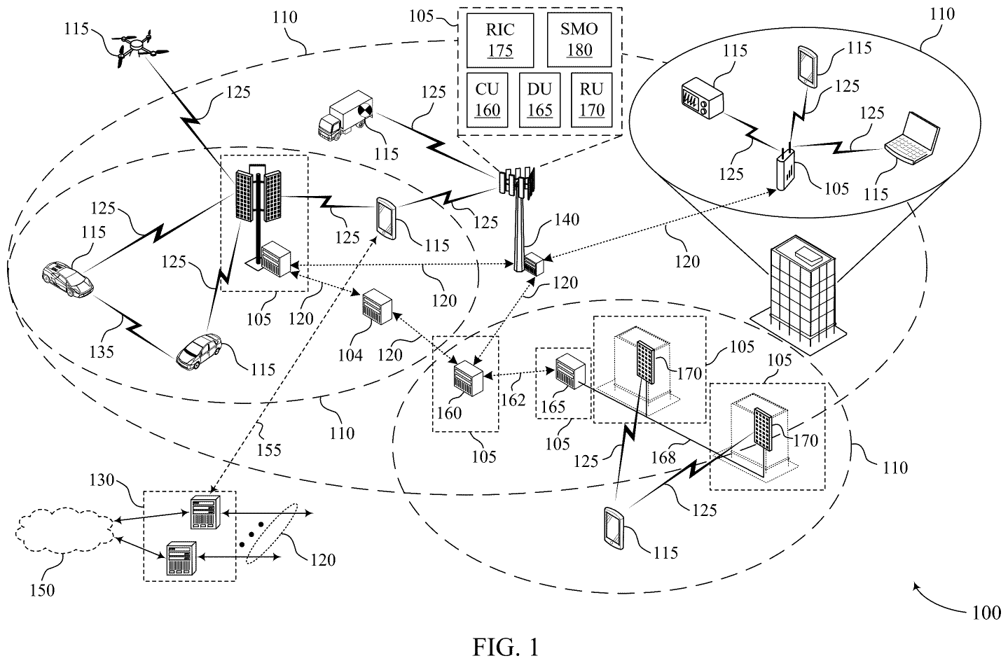

FIG. 1 shows an example of a wireless communications system 100 that supports a timing requirement for CLI reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, the UE 115 may be configured to support SBFD communications between the UE 115 and the network entity 105. In SBFD communications, the UE 115 may transmit an uplink communication to the network entity and another UE 115 may receive a downlink communication from the network entity 105 using different frequency resources and the same time resource (e.g., SBFD at the network entity 105). In some examples, the UE 115 may experience interference, such as intra-cell CLI, due to communications by other UEs 115. As an example, the UE 115 may receive, via a downlink sub-band of an SBFD slot, an uplink signal transmitted by another UE 115, where the aggressor and victim UEs are in the same cell. To mitigate CLI, the UE 115 may measure and report CLI values to the network entity 105. However, the UE 115 may not have enough time to be able to perform the CLI measurement and prepare the CLI report for transmission to the network entity 105.

A UE 115 may have a timing requirement for a timing between a receipt of a trigger event that triggers a CLI measurement on a CLI measurement resource and the CLI measurement resource. Participation in a CLI measurement and reporting process may depend on a scheduled timing between a resource of the trigger event and the CLI measurement resource being greater than or equal to the timing requirement. In some examples, the UE 115 may transmit, to the network entity 105, capability information that pertains to a UE capability for CLI measurement and CLI reporting. The capability information may be timing information, such as a CLI reporting timing and a CLI beam switching timing. The UE 115 may receive, from the network entity 105, control signaling that indicates a configuration for the CLI measurement and the CLI reporting. The configuration may be based on the timing information and on a timing requirement for the timing between a CLI measurement resource and a receipt of a trigger event that triggers the CLI measurement. The UE 115 may receive control signaling that is the trigger event that triggers a CLI measurement on the CLI measurement resource and that triggers transmission of a CLI report on a CLI report resource. The UE 115 may evaluate a duration between a resource of the trigger event and the CLI measurement resource to determine participation in a CLI measurement and reporting process. The participation in the CLI measurement and reporting process is based on the duration satisfying the timing requirement. If the duration satisfies the timing requirement, the UE 115 may transmit the CLI report.

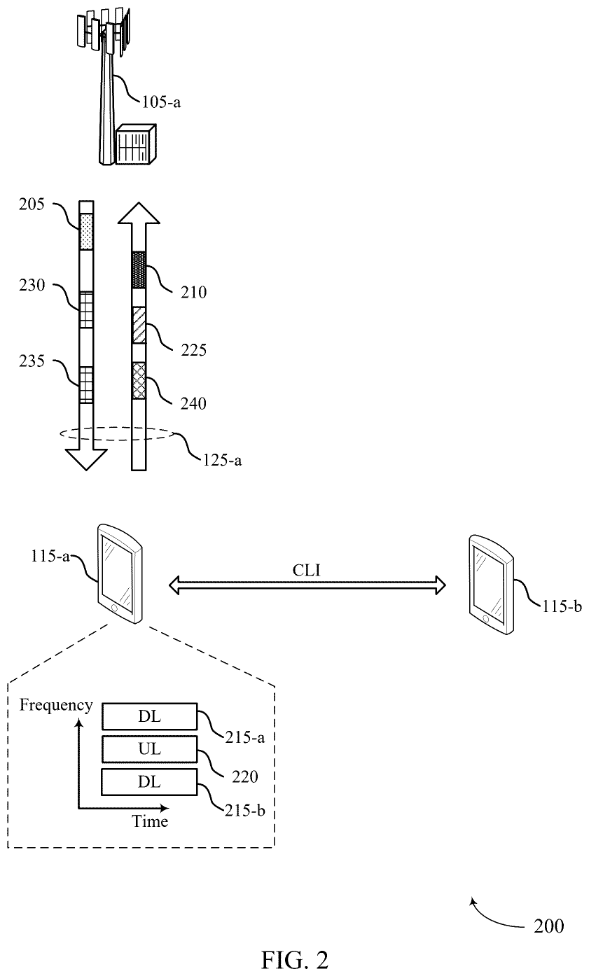

FIG. 2 shows an example of a wireless communications system 200 that supports a timing requirement for CLI reporting in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of the UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of a 6th generation (6G), a NR or LTE link between the UE 115-a and the network entity 105-a. The communication link 125-a may include bi-directional links that enable both uplink and downlink communications. For example, the network entity 105-a may transmit downlink signals 205, such as downlink control signaling and downlink data signals, to the UE 115-a using the communication link 125-a, and the UE 115-a may transmit uplink signals 210, including uplink control signaling and uplink data signals to the network entity 105-a using the communication link 125-a.

In some examples, the UE 115-a may be configured to support full duplex communications between the UE 115-a and the network entity 105-a. The UE 115-a may be configured to support SBFD communications, and the UE 115-a may communicate using the same time resources and different frequency resources. As illustrated in FIG. 2, a downlink resource (e.g., downlink resource 215-a and downlink resource 215-b) may be separate from an uplink resource 220 in the frequency domain. In some cases, the downlink resource and the uplink resource may be separated by a guard band. The UE 115-a may be configured to support in-band full duplex (IBFD) communications, and the UE 115-a may communicate using the same time and frequency resources. For IBFD communications, the downlink resource and uplink resource may share the same IBFD time and frequency resource, and the downlink resource and uplink resource may fully or partially overlap.

In some examples, the network entity 105-a may function in a full duplex mode and the UEs (e.g., UE 115-a and UE 115-b) may function in a half-duplex mode. In some cases, the UE 115-a may experience interference, such as CLI, due to communications by the UE 115-b. For example, the UE 115-a may transmit, via an uplink sub-band of an SBFD slot, an uplink signal 210 to the network entity 105-a, and the UE 115-b may receive a downlink signal from the network entity 105-a. The UE 115-a may experience interference (e.g., CLI) due to the transmission to the nearby the UE 115-b. In some examples, the network entity 105-a may function in a full duplex mode and the UEs (e.g., UE 115-a and UE 115-b) may function in a full duplex mode. In some cases, the UE 115-a may experience interference, such as CLI, due to communications by the UE 115-b. For example, the UE 115-a may transmit, via an IBFD slot, an uplink signal 210 to the network entity 105-a and may receive, via the IBFD slot, a downlink signal from the network entity 105-a. The UE 115-b may receive a downlink signal from the network entity 105-a, and the UE 115-a may experience interference (e.g., CLI) due to the transmission to the nearby the UE 115-b.

To mitigate CLI, the UE 115-a may measure and report CLI values to the network entity 105-a. In some cases, the UE 115-a may perform a layer one UE to UE CLI measurement and CLI report process. In some cases, the CLI measurement resources for the CLI measurement may be periodic, semi-persistent, or aperiodic measurement resources or resource set, such as sounding reference signal reference signal received power (SRS-RSRP) resources or CLI received signal strength indicator (CLI-RSSI) resources. The CLI reporting may be aperiodic, semi-persistent, or periodic, and the report quantities may be layer 1 SRS-RSRP (L1-SRS-RSRP), L1-CLI-RSSI, measurement resource indices or a combination thereof.

In some examples, the UE 115-a may transmit, to the network entity 105-a, capability information 225 pertaining to a UE capability for CLI measurement and CLI reporting. The UE 115-a may receive, from the network entity 105-a, control signaling 230 that indicates a configuration for the CLI measurement and CLI reporting. The UE 115-a may receive, from the network entity 105-a, control signaling 235 that triggers a CLI measurement and a CLI report. The UE 115-a may transmit, to the network entity 105-a, the CLI report 240.

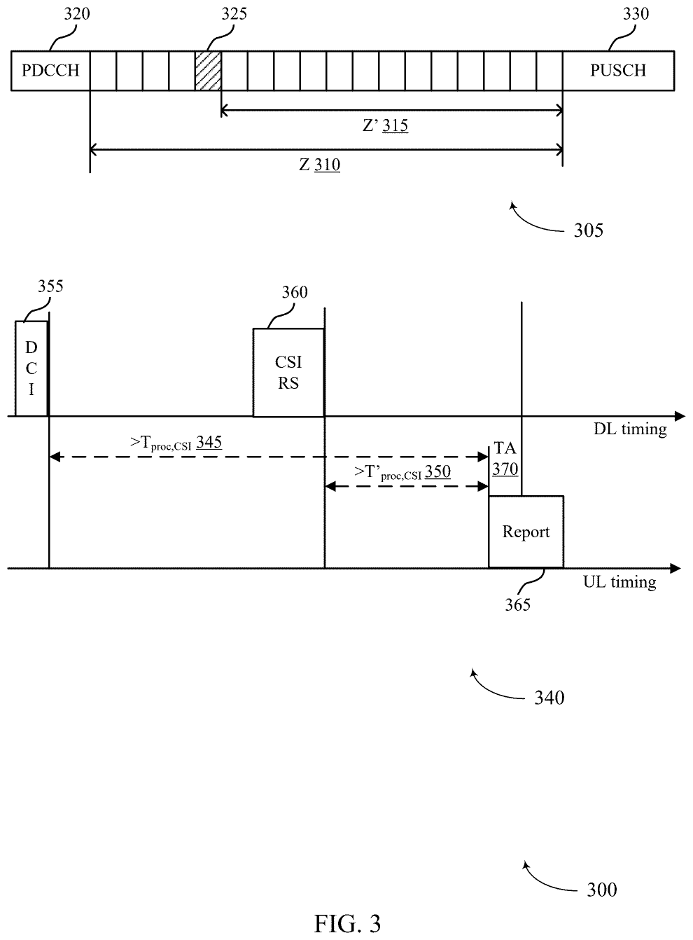

FIG. 3 shows examples of timing diagrams 300 that support a timing requirement for CLI reporting in accordance with one or more aspects of the present disclosure. Aspects of the timing diagrams 300 may implement, or be implemented by, aspects of wireless communications system 100 and the wireless communications system 200, or any combination thereof. For example, the timing diagrams 300 may be implemented by the UE 115-a as described with reference to FIGS. 1 and 2.

In some cases, the CLI measurement and CLI report process may be modeled on channel state information (CSI) process. For example, CSI processing unit, CPU occupation rule and timeline for L1 beam reporting may be used as a starting point for L1 UE-to-UE CLI measurement and reporting. CSI processing may be associated with CSI timing requirements to guarantee that the UE 115-a has enough time to generate the CSI report. The timing diagram 305 illustrates the CSI timing requirements or CSI computation delay requirements Z 310 and Z′ 315. For aperiodic triggering of CSI measurement and CSI reporting, a CSI trigger may be received on a physical downlink control channel (PDCCH) resource 320 that triggers CSI measurement on a CSI measurement resource 325 and triggers transmission of a CSI report on a CSI report resource 330 (e.g., physical uplink shared channel (PUSCH) resource). The timing requirement Z′ is the timing for the UE 115-a to prepare the CSI report on the CSI report resource 330, the timing requirement Z is the timing for the UE 115- to prepare for the CSI measurement and the CSI report, and the difference between Z and Z′ is the timing for the UE 115-a to decode the downlink control information (DCI) received on the PDCCH resource 320 and prepare for the CSI measurement on the CSI measurement resource 325. The timing requirement Z may a quantity of symbols between a symbol of the PDCCH resource 320 and a symbol of the CSI report resource 330, and the timing requirement Z′ may a quantity of symbols between a symbol of the CSI measurement resource 325 and a symbol of the CSI report resource 330. In some cases, each latency class, such as a low-latency class, high-latency class, or latency for beam reporting, may have respective timing requirements Z and Z′ for different carrier spacings. The latency for beam reporting may be based on a beam report timing or a aperiodic CSI reference signal (A-CSI-RS) beam switch timing. The beam report timing may be a quantity of symbols (Xᵢ) between the last symbol of a synchronization signal block (SSB) or CSI reference signal (CSI-RS) and the first symbol of the transmission channel containing the beam report for different subcarrier spacings. The A-CSI-RS beam switching timing may be a minimum time between the DCI triggering of AP-CSI-RS (PDCCH resource 320) and aperiodic CSI transmission (CSI measurement resource 325) may be at least KBᵢ symbols (e.g., symbols measured from last symbol containing the indication to the first symbol of the CSI-RS) for different subcarrier spacings. The beam reporting timing and the A-CSI-RS beam switching timing may be UE capability information.

The timing requirements Z and Z′ that are defined in terms of symbols may be converted to an absolute time values T_{proc,CSI} and T′_{proc,CSI}. For example, T_{proc,CSI}=(Z)(2048+144)·κ2^{-μ}·T_{c}+T_{switch} and T′_{proc,CSI}=(Z′)(2048+144)·κ2^{-μ}·T_{c}, are based on Z and Z′, where κ is symbol length, p is subcarrier spacing, T_{c} is a timing constant, and T_{switch} is an offset. The timing diagram 340 illustrates the CSI timing requirements or CSI computation delay requirements T_{proc,CSI} 345 and T′_{proc,CSI} 350. For aperiodic triggering of CSI measurement and CSI reporting, a CSI trigger or DCI may be received on a PDCCH resource 355 that triggers CSI measurement of a CSI-RS on a CSI measurement resource 360 and triggers transmission of a CSI report on a CSI report resource 365. The DCI on the PDCCH resource 355 and the CSI-RS on the CSI measurement resource 360 are defined based on the downlink timing, and the CSI report on the CSI report resource 330 is defined based on the uplink timing. A timing advance (TA) 370 is the difference between the uplink timing and the downlink timing to account for a propagation delay. To satisfy the T_{proc,CSI} 345 and T′_{proc,CSI} 350 the timing advance may be included. If the T′_{proc,CSI} 350 is satisfied, the T′_{proc,CSI} 350 considering the timing advance 370 may not be satisfied. In some examples, CLI measurements are applicable for a radio resource control (RRC) connected mode. In some cases, a constant offset relative to the downlink reference timing may be defined when measuring the CLI measurement resource not on downlink timing (e.g., CLI measurement resource on uplink timing). The constant offset value may be derived by UE implementation and may be at least T_{c}*N_{TA_offset}

In some cases, a DCI that triggers A-CSI reporting may also trigger CSI-RS or CSI interference measurement (CSI-IM). A triggering code point in the DCI may map to a trigger state that indicates CSI-RS or CSI-IM measurement resources. The UE 115-a may determine the slot for the CSI-RS or CSI-IM measurement resources based on an aperiodicTriggerOffset RRC configuration of NZP-CSI-ResourceSet. In some cases, the CSI-IM may be assumed to be in the same slot as the CSI-RS and no timing information may be defined for the CSI-IM. The aperiodicTriggerOffset may indicate an integer corresponding to the slot for the CSI-RS measurement resources.

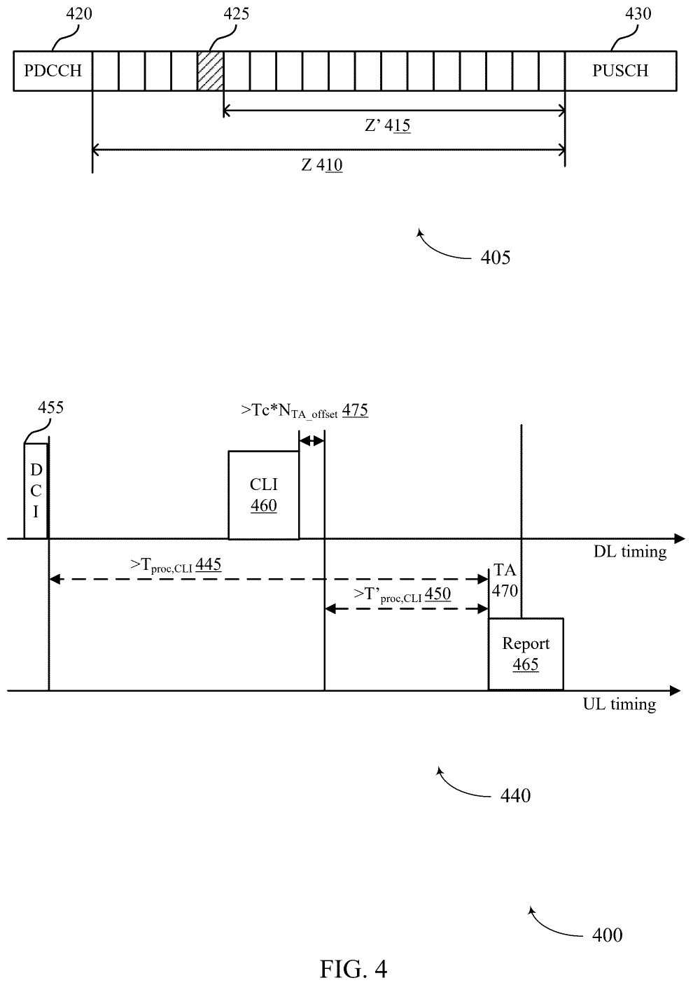

FIG. 4 shows examples of timing diagrams 400 that support a timing requirement for CLI reporting in accordance with one or more aspects of the present disclosure. Aspects of the timing diagrams 400 may implement, or be implemented by, aspects of wireless communications system 100 and the wireless communications system 200, or any combination thereof. For example, the timing diagrams 400 may be implemented by the UE 115-a as described with reference to FIGS. 1 and 2.

[some cases, the CLI measurement and CLI report process may be modeled on CSI process. The timing diagram 405 illustrates the CLI timing requirements or CLI computation delay requirements Z 410 and Z′ 415 that may be similar to the Z and Z′ for CSI. For aperiodic triggering of CLI measurement and CLI reporting, a CLI trigger may be received on a PDCCH resource 420 that triggers CLI measurement on a CLI measurement resource 425 and triggers transmission of a CLI report on a CLI report resource 430. The timing requirement Z′ may be the timing for the UE 115-a to prepare the CLI report on the CLI report resource 430, the timing requirement Z is the timing for the UE 115- to prepare for the CLI measurement and the CLI report. The difference between Z and Z′ is the timing for the UE 115-a to process and start monitoring for the aperiodic measurement resource or the CLI measurement resource 425. The timing requirement Z may a quantity of symbols between a symbol of the PDCCH resource 420 and a symbol of the CLI report resource 430, and the timing requirement Z′ may a quantity of symbols between a symbol of the CLI measurement resource 425 and a symbol of the CLI report resource 430. In some cases, each latency class, such as a low-latency class, high-latency class, or latency for beam reporting, may have respective timing requirements Z and Z′ for different carrier spacings.

The CLI timing requirements Z and Z′ that are defined in terms of symbols may be converted to an absolute time values T_{proc,CLI} and T′_{proc,CLI}. The timing diagram 440 illustrates the CLI timing requirements or CLI computation delay requirements T_{proc,CLI} 445 and T′_{proc,CSI} 450. For aperiodic triggering of CLI measurement and CLI reporting, a CLI trigger or DCI may be received on a PDCCH resource 455 that triggers CLI measurement on a CLI measurement resource 460 and triggers transmission of a CLI report on a CLI report resource 465. In some cases, the CLI timing requirements Z and Z′ (and the values T_{proc,CLI} and T′_{proc,CLI}) may be defined to include the effect of the timing advance 470, and the timing advance 470 may make the timing requirement more stringent as uplink is advanced. In the CLI framework, the CLI measurement timing may be assumed to have a constant offset relative to the downlink reference timing. The constant offset value 475 may be derived by UE implementation and may be at least T_{c}*N_{TA_offset}. where N_{TA_offset} is a timing offset value. Advancing the CLI measurement resource 460 by the constant offset value 475 of at least T_{c}*N_{TA_offset} may reduce the time gap between the trigger DCI of the PDCCH resource 455 and the AP resource or CLI measurement resource 460.

In some cases, if the L1 CLI measurement resource 460 is using the downlink timing, then the UE 115-a may use the same CSI timing definition (e.g., T_{proc,CSI} and T′_{proc,CSI}) for the start and end for the CLI timing requirements (e.g., T_{proc,CLI} and T′_{proc,CLI}). For L1 CLI measurement in the uplink subband (e.g., CLI-RSRP), the measurement timing may be different from the downlink timing. When the measurement timing is different from the downlink timing, the CLI framework may be up to UE implementation as the constant offset value 475 may be derived by UE implementation and may be at least T_{c}*N_{TA_offset}. In the case of UE implementation, the network entity 105-a may be indicated the CLI measurement timing or the CLI measurement timing may be configured, so the network entity 105-a may trigger the CLI measurement to satisfy the timing requirement (e.g., Z or Z′). In some cases, when the measurement timing is different from the downlink timing, the UE 115-a may use the uplink timing and may consider the timing advance.

For the case when the measurement timing is different from the downlink timing, the CLI timing requirement (e.g., Z or Z′) may be defined similar to the CSI timing requirement with a change of adding an offset value (T_{CLI}) or constant to the timing equation (T_{proc,CSI}). For example, the offset value (T_{CLI}) may be a constant added to the timing equation to account for the difference between the downlink timing and the CLI measurement time as T_{proc,CLI}=(Z)(2048+144)·κ2^{-μ}·T_{c}+T_{Switch}+T_{CLI}. The offset value may be sufficient to compensate for a forward temporal shifting of the CLI measurement resource 460.

For the case when the measurement timing is different from the downlink timing, the CLI timing requirement may be a dedicated CLI requirement for Z and Z′. With the dedicated CLI requirement for Z and Z′, the UE 115-a may satisfy the timing requirements T_{proc,CLI} and T′_{proc,CLI}. In some cases, the dedicated CLI requirement for Z and Z′ may be the Z and Z′ values for CSI plus an offset. For example, the Z for CLI may be a value greater than one times the Z for CSI (e.g., Z_{CLI}=α*Z_{CSI}), and the Z′ for CLI may be a value greater than one times the Z′ for CSI (e.g., Z′_{CLI}=α*Z′_{CSI}).

In some examples, the UE 115-a may transmit UE capability information that pertains to a UE capability for CLI measurement and CLI reporting. The capability information may be a L1 CLI reporting timing CLIReportTiming (Xᵢ) or a CLI beam switching timing CLlbeamSwitchTiming (KBᵢ). The CLI beam switching timing may be applicable for FR2 (subcarrier spacing SCS>60 kHz). The CLI reporting timing may be defined as the quantity of symbols, Xi, between the last symbol of the CLI-resource and the first symbol of the transmission channel containing CLI report; the CLI reporting time is at least Xᵢ, where i=1, 2, 3, 4 corresponding to 15, 30, 60, 120 kHz SCS. The CLI beam switching timing may be defined as a minimum time between the DCI triggering of AP-CLI resource and aperiodic CLI measurements occasions; the CLI beam switching timing may be at least KBᵢ symbols, and KBᵢ may be the quantity of symbols measured from the last symbol containing the indication to the first symbol of the CLI resource, where i is the index of SCS, i=1, 2 corresponding to 60, 120 kHz SCS.

In some cases, for the CSI framework, the triggering offset in the DCI for AP CSI-RS may pick a slot such that the timing requirement (e.g., Z requirement) is satisfied. Similarly, for CLI, a triggering offset in the DCI for AP CLI may pick a slot such that the CLI Z requirement is satisfied. In some examples, a new timing requirement for AP CLI triggering may be defined. In some cases, an offset may be added to the Z and Z′ values corresponding CSI timing requirements tables with Z1, Z2, or Z3 used as the CLI timing reference with the added offset. In some cases, the CLI Z values may be the same as the CSI Z values. In some examples, a minimum triggering offset (K_{CLI}) may be defined for AP CLI resource. The minimum triggering offset may be a non-zero value, and the minimum triggering offset may effectively increase Z by K_{CLI} slots.

In some cases, the timing requirement for CLI may be violated. In some cases, when the DCI triggers a CLI report on PUSCH, if the first symbol to carry the corresponding CLI report including the effect of the timing advance start earlier than a symbol Z, the UE 115-a may ignore the scheduling DCI if no HARQ-ACK or transport block is multiplexed on the PUSCH. In some cases, when the DCI triggers a CLI report on PUSCH, if the first symbol to carry the n-th CLI report including the effect of the timing advance start earlier than a symbol Z′, the UE 115-a may ignore the scheduling DCI if the quantity of triggered reports is one and no HARQ-ACK or transport block is multiplexed on the PUSCH, otherwise, the UE is not required to update the CLI for the n-th triggered CLI report. In some cases, if there is no valid downlink slot for the CLI resource corresponding to a CLI report setting in a serving cell, the CLI report is omitted in the uplink slot. In some cases, if the CLI timing requirement is not satisfied, the UE 115-a may refrain from transmitting the CLI report. In some examples, if the CLI timing requirement is not satisfied, the UE 115-a may transmit a partial CLI report, and the partial CLI report may include a quantity of CLI metrics less than a scheduled quantity of CLI measurements. For example, four CLI measurement may be scheduled on four CLI measurement resources, and the partial report includes less than 4 CLI measurements. In some cases, if the CLI timing requirement is satisfied, the UE 115-a may transmit the CLI report.

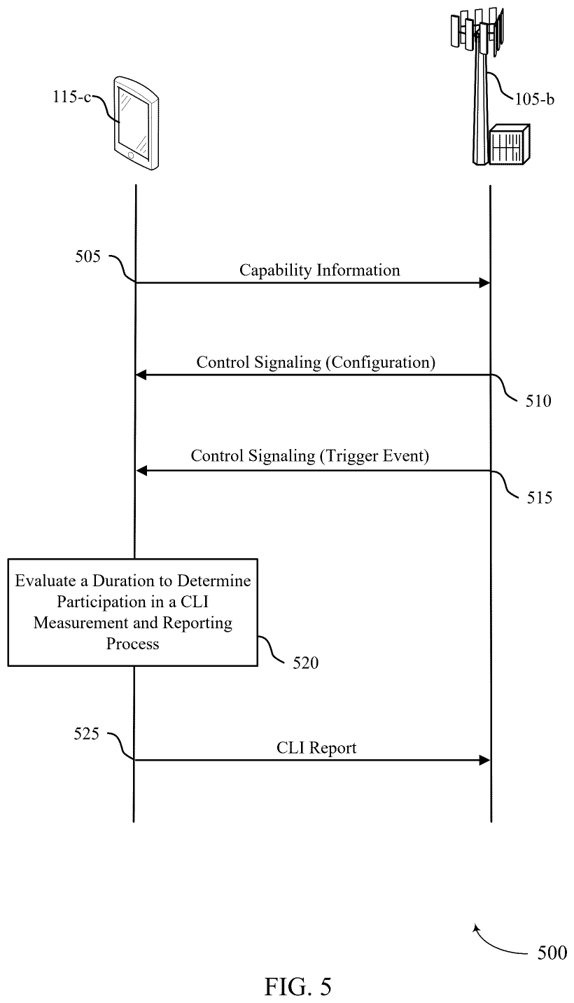

FIG. 5 shows an example of a process flow 500 that supports a timing requirement for CLI reporting in accordance with one or more aspects of the present disclosure. In some examples, the process flow 500 may implement or be implemented by aspects of the wireless communications systems 100 and 200 as described with reference to FIGS. 1 and 2, respectively. For example, the process flow 500 may be implemented by a network entity 105-b, which may be an example of the network entities 105 as described with reference to FIGS. 1 and 2. The process flow 500 may be implemented by a UE 115-c, which may be an example of the UEs as described with reference to FIGS. 1 and 2.

In some examples, the operations illustrated in process flow 500 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 505, the UE 115-c may transmit, to the network entity 105-b, capability information that pertains to a UE capability for CLI measurement and CLI reporting. The capability information may include timing information associated with a timing between a CLI measurement resource and receipt of a trigger event that triggers the CLI measurement on the CLI measurement resource. In some examples, the timing information is a CLI reporting timing, and the CLI reporting timing may indicate a quantity of symbols between a symbol of the CLI measurement resource and a symbol of the CLI report resource. In some examples, the timing information comprises a CLI beam switching timing, and the CLI beam switching timing may indicate a time between a resource of the second control signaling and the CLI measurement resource.

At 510, the UE 115-c may receive, from the network entity 105-b, first control signaling that indicates a configuration for the CLI measurement and the CLI reporting based on the timing information and on a timing requirement for the timing between the CLI measurement resource and receipt of the trigger event.

In some examples, the timing requirement may be based on a first quantity of symbols between a symbol of the second control signaling and a symbol of the CLI report resource, a second quantity of symbols between a symbol of the CLI measurement resource and the symbol of the CLI report resource, or both. In some examples, the first quantity is based on the CLI beam switching timing. In some examples, the timing requirement may be based on a timing advance, and the timing advance may be a difference between a downlink reference timing and an uplink reference timing.

At 515, the UE 115-c may receive, from the network entity 105-b, second control signaling that is the trigger event that triggers the CLI measurement on the CLI measurement resource and that triggers transmission of a CLI report on a CLI report resource. In some examples, the second control signaling may a triggering offset, and the triggering offset may indicate the CLI measurement resource that satisfies the timing requirement. In some examples, the triggering offset is a non-zero value. In some examples, the triggering offset is based on the first quantity of symbols between a symbol of the second control signaling and a symbol of the CLI report resource, the second quantity of symbols between a symbol of the CLI measurement resource and the symbol of the CLI report resource, or both, and a timing offset.

At 520, the UE 115-c may evaluating a duration between a resource of the trigger event and the CLI report resource to determine participation in a CLI measurement and reporting process. In some examples, the participation in the CLI measurement and reporting process may be based on the duration satisfying the timing requirement based on an offset value, and the offset value may be sufficient to compensate for a forward temporal shifting of the CLI measurement resource. In some examples, the participation in the CLI measurement and reporting process may be based on the duration satisfying the first quantity of symbols or the second quantity of symbols and an offset value, and the offset value may be sufficient to compensate for a forward temporal shifting of the CLI measurement resource.

At 525, the UE 115-c may transmit, to the network entity 105-b, the CLI report comprising one or more CLI metrics based on the duration satisfying the timing requirement. In some examples, the UE 115-c may refrain from transmitting the CLI report based on the duration not satisfying the timing requirement. In some examples, the UE 115-c may transmit, to the network entity 105-b, a partial CLI report based on the duration not satisfying the timing requirement, and the partial CLI report includes a quantity of CLI metrics less than a scheduled quantity of CLI measurements.

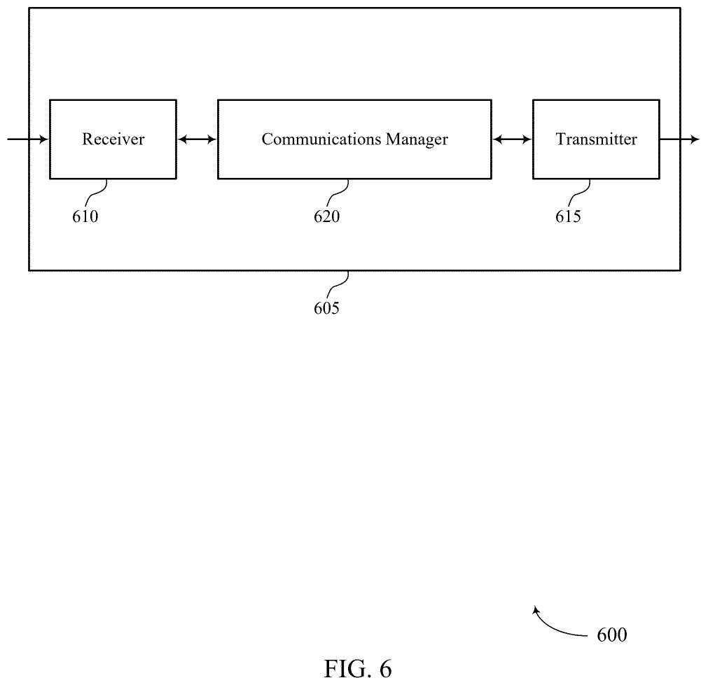

FIG. 6 shows a block diagram 600 of a device 605 that supports a timing requirement for CLI reporting in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to timing requirement for CLI reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to timing requirement for CLI reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of timing requirement for CLI reporting as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The communications manager 620 is capable of, configured to, or operable to support a means for receiving, from the network entity, first control signaling that indicates a configuration for the CLI measurement and the CLI reporting based on the timing information and on a timing requirement for the timing between the CLI measurement resource and receipt of the trigger event. The communications manager 620 is capable of, configured to, or operable to support a means for receiving, from the network entity, second control signaling that is the trigger event that triggers the CLI measurement on the CLI measurement resource and that triggers transmission of a CLI report on a CLI report resource.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

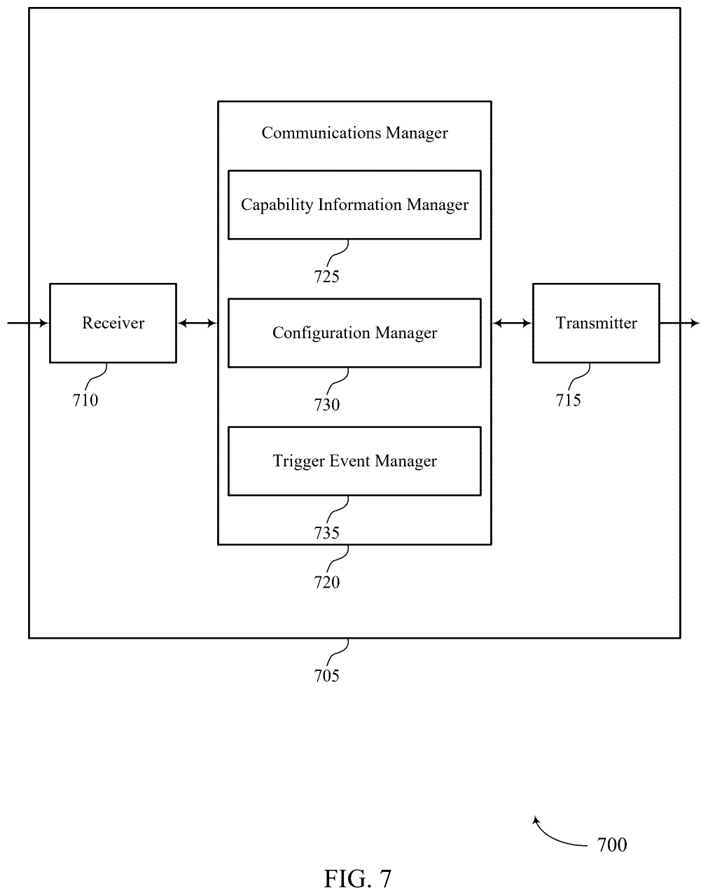

FIG. 7 shows a block diagram 700 of a device 705 that supports a timing requirement for CLI reporting in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to timing requirement for CLI reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to timing requirement for CLI reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of timing requirement for CLI reporting as described herein. For example, the communications manager 720 may include a capability information manager 725, a configuration manager 730, a trigger event manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The capability information manager 725 is capable of, configured to, or operable to support a means for transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The configuration manager 730 is capable of, configured to, or operable to support a means for receiving, from the network entity, first control signaling that indicates a configuration for the CLI measurement and the CLI reporting based on the timing information and on a timing requirement for the timing between the CLI measurement resource and receipt of the trigger event. The trigger event manager 735 is capable of, configured to, or operable to support a means for receiving, from the network entity, second control signaling that is the trigger event that triggers the CLI measurement on the CLI measurement resource and that triggers transmission of a CLI report on a CLI report resource.

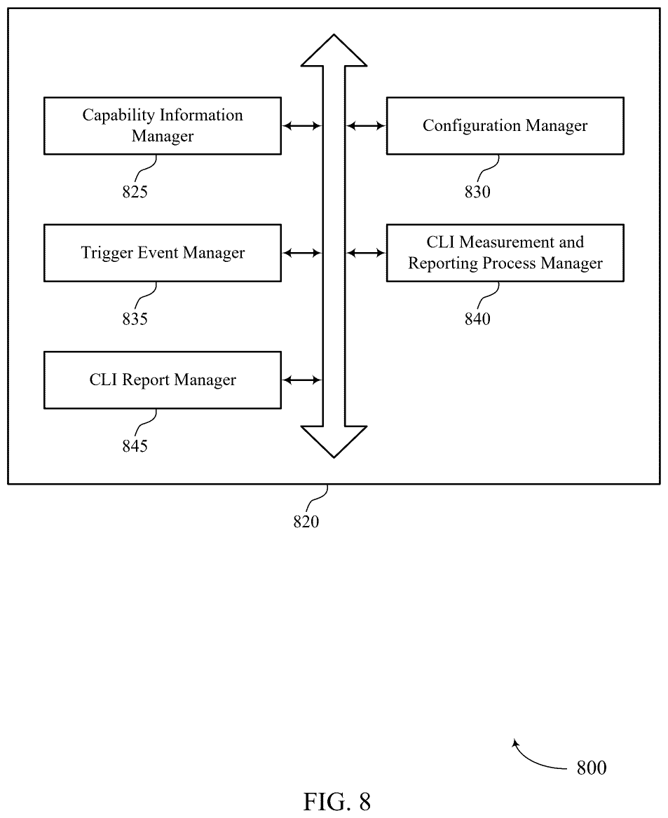

FIG. 8 shows a block diagram 800 of a communications manager 820 that supports a timing requirement for CLI reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of timing requirement for CLI reporting as described herein. For example, the communications manager 820 may include a capability information manager 825, a configuration manager 830, a trigger event manager 835, a CLI measurement and reporting process manager 840, a CLI report manager 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The capability information manager 825 is capable of, configured to, or operable to support a means for transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The configuration manager 830 is capable of, configured to, or operable to support a means for receiving, from the network entity, first control signaling that indicates a configuration for the CLI measurement and the CLI reporting based on the timing information and on a timing requirement for the timing between the CLI measurement resource and receipt of the trigger event. The trigger event manager 835 is capable of, configured to, or operable to support a means for receiving, from the network entity, second control signaling that is the trigger event that triggers the CLI measurement on the CLI measurement resource and that triggers transmission of a CLI report on a CLI report resource.

In some examples, the CLI measurement and reporting process manager 840 is capable of, configured to, or operable to support a means for evaluating a duration between a resource of the trigger event and the CLI report resource to determine participation in a CLI measurement and reporting process, where participation in the CLI measurement and reporting process is based on the duration satisfying the timing requirement based on an offset value, where the offset value is sufficient to compensate for a forward temporal shifting of the CLI measurement resource.

In some examples, the timing requirement is based on a first quantity of symbols between a symbol of the second control signaling and a symbol of the CLI report resource, a second quantity of symbols between a symbol of the CLI measurement resource and the symbol of the CLI report resource, or both.

In some examples, the CLI measurement and reporting process manager 840 is capable of, configured to, or operable to support a means for evaluating a duration between a resource of the trigger event and the CLI report resource to determine participation in a CLI measurement and reporting process, where participation in the CLI measurement and reporting process is based on the duration satisfying the first quantity of symbols or the second quantity of symbols and an offset value, where the offset value is sufficient to compensate for a forward temporal shifting of the CLI measurement resource.

In some examples, the timing requirement is based on a timing advance. In some examples, the timing advance includes a difference between a downlink reference timing and an uplink reference timing.

In some examples, the timing information includes a CLI reporting timing. In some examples, the CLI reporting timing indicates a quantity of symbols between a symbol of the CLI measurement resource and a symbol of the CLI report resource. In some examples, the timing requirement is based on a first quantity of symbols between a symbol of the second control signaling and a symbol of the CLI report resource, a second quantity of symbols between a symbol of the CLI measurement resource and the symbol of the CLI report resource, or both. In some examples, the second quantity is based on the CLI reporting timing.

In some examples, the timing information includes a CLI beam switching timing. In some examples, the CLI beam switching timing indicates a time between a resource of the second control signaling and the CLI measurement resource. In some examples, the timing requirement is based on a first quantity of symbols between a symbol of the second control signaling and a symbol of the CLI report resource, or a second quantity of symbols between a symbol of the CLI measurement resource and the symbol of the CLI report resource, or both. In some examples, the first quantity is based on the CLI beam switching timing.

In some examples, the second control signaling indicates a triggering offset. In some examples, the triggering offset indicates the CLI measurement resource that satisfies the timing requirement.

In some examples, the triggering offset includes a non-zero value.

In some examples, the second control signaling indicates a triggering offset. In some examples, the triggering offset is based at least on a first quantity of symbols between a symbol of the second control signaling and a symbol of the CLI report resource, or a second quantity of symbols between a symbol of the CLI measurement resource and the symbol of the CLI report resource, or both, and a timing offset.

In some examples, the CLI measurement and reporting process manager 840 is capable of, configured to, or operable to support a means for evaluating a duration between a resource of the trigger event and the CLI report resource to determine participation in a CLI measurement and reporting process, where participation in the CLI measurement and reporting process is based on the duration satisfying the timing requirement. In some examples, the CLI report manager 845 is capable of, configured to, or operable to support a means for refraining from transmitting the CLI report based on the duration not satisfying the timing requirement.

In some examples, the CLI measurement and reporting process manager 840 is capable of, configured to, or operable to support a means for evaluating a duration between a resource of the trigger event and the CLI report resource to determine participation in a CLI measurement and reporting process, where participation in the CLI measurement and reporting process is based on the duration satisfying the timing requirement. In some examples, the CLI report manager 845 is capable of, configured to, or operable to support a means for transmitting a partial CLI report based on the duration not satisfying the timing requirement, where the partial CLI report includes a quantity of CLI metrics less than a scheduled quantity of CLI measurements.

In some examples, the CLI measurement and reporting process manager 840 is capable of, configured to, or operable to support a means for evaluating a duration between a resource of the trigger event and the CLI report resource to determine participation in a CLI measurement and reporting process, where participation in the CLI measurement and reporting process is based on the duration satisfying the timing requirement. In some examples, the CLI report manager 845 is capable of, configured to, or operable to support a means for transmitting the CLI report including one or more CLI metrics based on the duration satisfying the timing requirement.

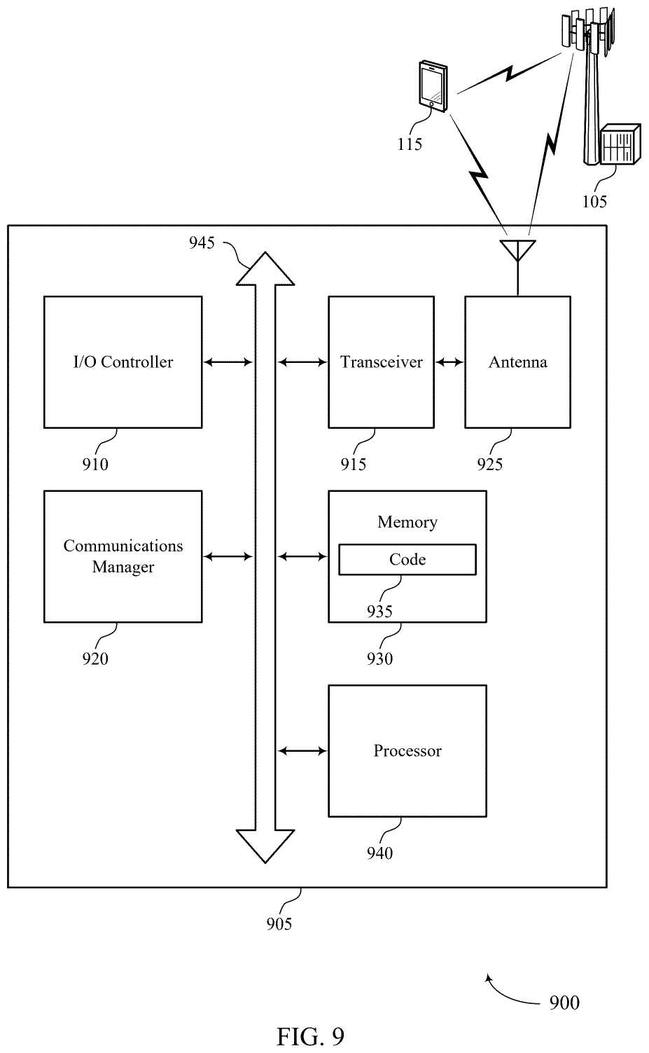

FIG. 9 shows a diagram of a system 900 including a device 905 that supports a timing requirement for CLI reporting in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting timing requirement for CLI reporting). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The communications manager 920 is capable of, configured to, or operable to support a means for receiving, from the network entity, first control signaling that indicates a configuration for the CLI measurement and the CLI reporting based on the timing information and on a timing requirement for the timing between the CLI measurement resource and receipt of the trigger event. The communications manager 920 is capable of, configured to, or operable to support a means for receiving, from the network entity, second control signaling that is the trigger event that triggers the CLI measurement on the CLI measurement resource and that triggers transmission of a CLI report on a CLI report resource.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of timing requirement for CLI reporting as described herein, or the at least one processor 940 and the at least one memory 930 may be otherwise configured to, individually or collectively, perform or support such operations.

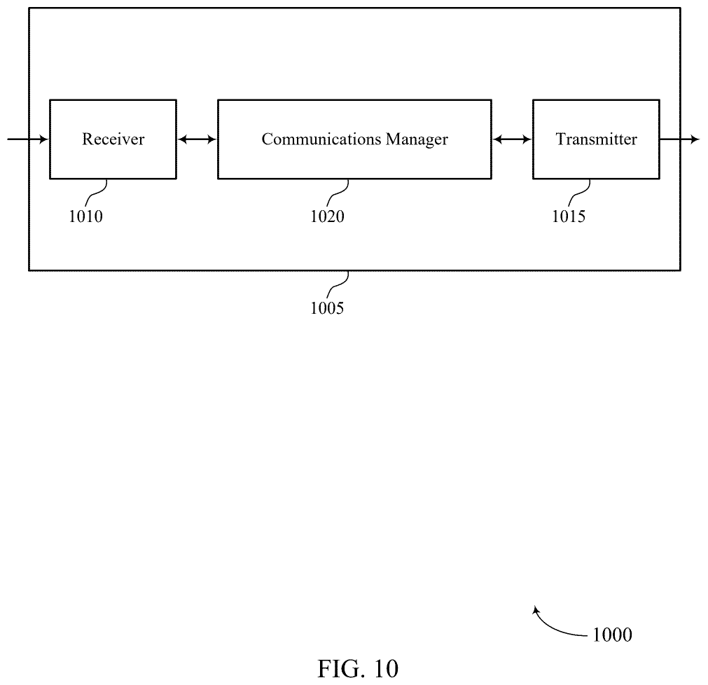

FIG. 10 shows a block diagram 1000 of a device 1005 that supports a timing requirement for CLI reporting in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of timing requirement for CLI reporting as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for obtaining, from a UE, capability information that pertains to a UE capability for CLI measurement and CLI reporting, where the capability information includes timing information associated with a timing between a CLI measurement resource and receipt of a trigger event that triggers the CLI measurement on the CLI measurement resource. The communications manager 1020 is capable of, configured to, or operable to support a means for outputting, to the UE, first control signaling that indicates a configuration for the CLI measurement and the CLI reporting based on the timing information and on a timing requirement for the timing between the CLI measurement resource and receipt of the trigger event. The communications manager 1020 is capable of, configured to, or operable to support a means for outputting, to the UE, second control signaling that is the trigger event that triggers the CLI measurement on the CLI measurement resource and that triggers transmission of a CLI report on a CLI report resource.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

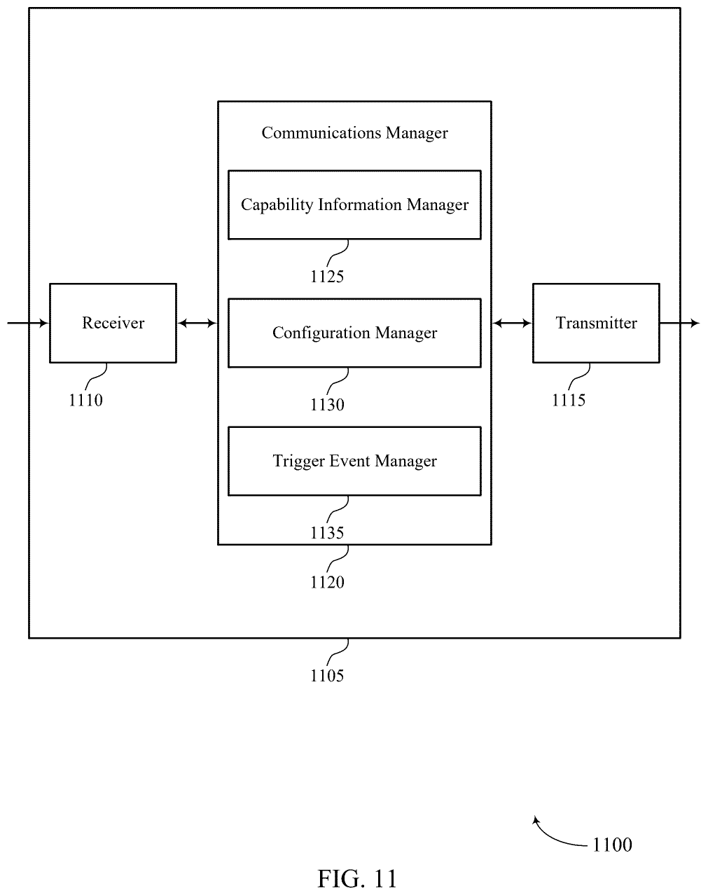

FIG. 11 shows a block diagram 1100 of a device 1105 that supports a timing requirement for CLI reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of timing requirement for CLI reporting as described herein. For example, the communications manager 1120 may include a capability information manager 1125, a configuration manager 1130, a trigger event manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The capability information manager 1125 is capable of, configured to, or operable to support a means for obtaining, from a UE, capability information that pertains to a UE capability for CLI measurement and CLI reporting, where the capability information includes timing information associated with a timing between a CLI measurement resource and receipt of a trigger event that triggers the CLI measurement on the CLI measurement resource. The configuration manager 1130 is capable of, configured to, or operable to support a means for outputting, to the UE, first control signaling that indicates a configuration for the CLI measurement and the CLI reporting based on the timing information and on a timing requirement for the timing between the CLI measurement resource and receipt of the trigger event. The trigger event manager 1135 is capable of, configured to, or operable to support a means for outputting, to the UE, second control signaling that is the trigger event that triggers the CLI measurement on the CLI measurement resource and that triggers transmission of a CLI report on a CLI report resource.

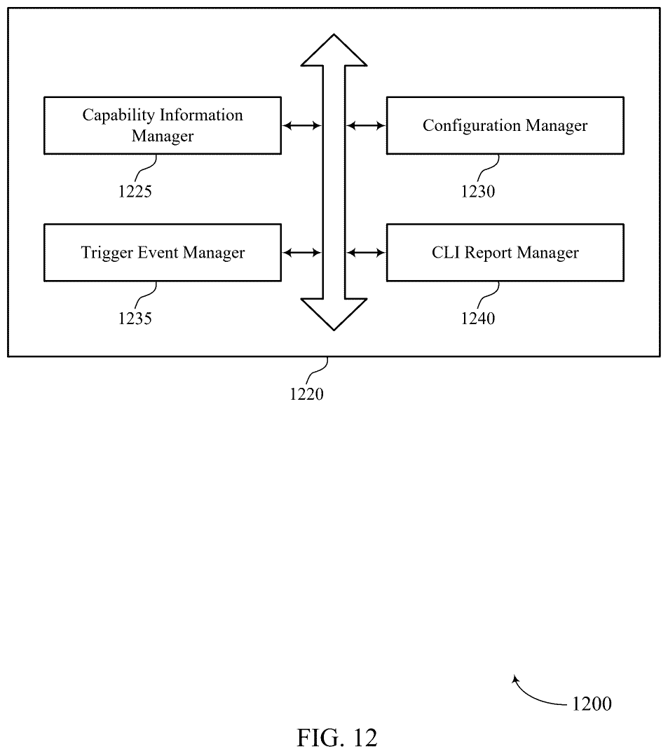

FIG. 12 shows a block diagram 1200 of a communications manager 1220 that supports a timing requirement for CLI reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of timing requirement for CLI reporting as described herein. For example, the communications manager 1220 may include a capability information manager 1225, a configuration manager 1230, a trigger event manager 1235, a CLI report manager 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The capability information manager 1225 is capable of, configured to, or operable to support a means for obtaining, from a UE, capability information that pertains to a UE capability for CLI measurement and CLI reporting, where the capability information includes timing information associated with a timing between a CLI measurement resource and receipt of a trigger event that triggers the CLI measurement on the CLI measurement resource. The configuration manager 1230 is capable of, configured to, or operable to support a means for outputting, to the UE, first control signaling that indicates a configuration for the CLI measurement and the CLI reporting based on the timing information and on a timing requirement for the timing between the CLI measurement resource and receipt of the trigger event. The trigger event manager 1235 is capable of, configured to, or operable to support a means for outputting, to the UE, second control signaling that is the trigger event that triggers the CLI measurement on the CLI measurement resource and that triggers transmission of a CLI report on a CLI report resource.

In some examples, the timing requirement is based on a first quantity of symbols between a symbol of the second control signaling and a symbol of the CLI report resource, a second quantity of symbols between a symbol of the CLI measurement resource and the symbol of the CLI report resource, or both.

In some examples, the timing requirement is based on a timing advance. In some examples, the timing advance includes a difference between a downlink reference timing and an uplink reference timing.

In some examples, the timing information includes a CLI reporting timing. In some examples, the CLI reporting timing indicates a quantity of symbols between a symbol of the CLI measurement resource and a symbol of the CLI report resource. In some examples, the timing requirement is based on a first quantity of symbols between a symbol of the second control signaling and a symbol of the CLI report resource, a second quantity of symbols between a symbol of the CLI measurement resource and the symbol of the CLI report resource, or both. In some examples, the second quantity is based on the CLI reporting timing.

In some examples, the timing information includes a CLI beam switching timing. In some examples, the CLI beam switching timing indicates a time between a resource of the second control signaling and the CLI measurement resource. In some examples, the timing requirement is based on a first quantity of symbols between a symbol of the second control signaling and a symbol of the CLI report resource, a second quantity of symbols between a symbol of the CLI measurement resource and the symbol of the CLI report resource, or both. In some examples, the first quantity is based on the CLI beam switching timing.

In some examples, the second control signaling indicates a triggering offset. In some examples, the triggering offset indicates the CLI measurement resource that satisfies the timing requirement.

In some examples, the triggering offset includes a non-zero value.

In some examples, the second control signaling indicates a triggering offset. In some examples, the triggering offset is based at least on a first quantity of symbols between a symbol of the second control signaling and a symbol of the CLI report resource, a second quantity of symbols between a symbol of the CLI measurement resource and a symbol of the CLI report resource, or both and a timing offset.

In some examples, the CLI report manager 1240 is capable of, configured to, or operable to support a means for obtaining the CLI report including one or more CLI metrics.

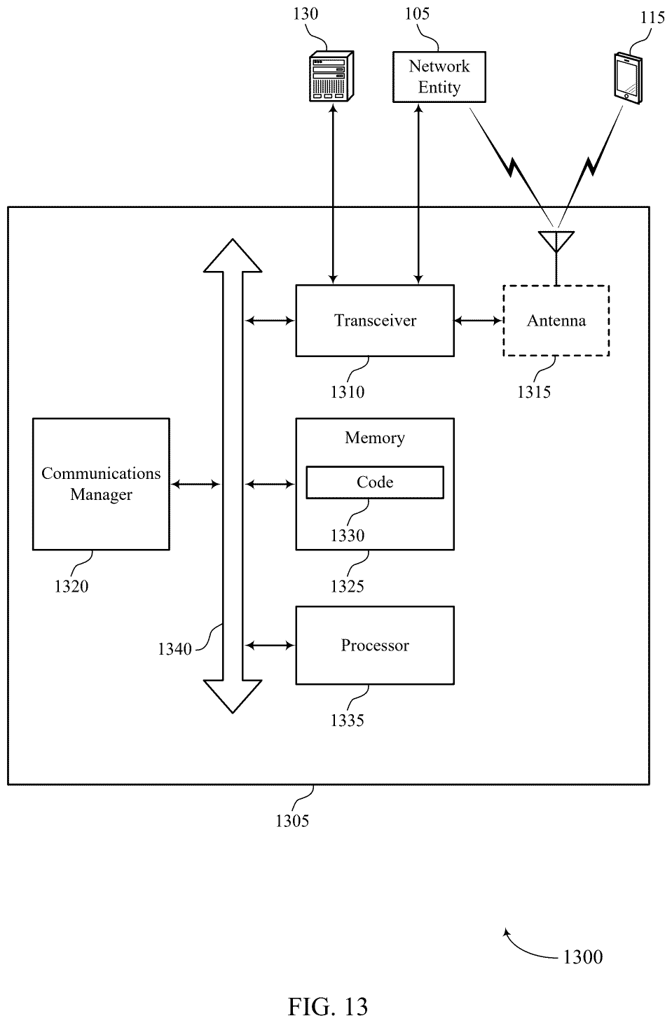

FIG. 13 shows a diagram of a system 1300 including a device 1305 that supports a timing requirement for CLI reporting in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting timing requirement for CLI reporting). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for obtaining, from a UE, capability information that pertains to a UE capability for CLI measurement and CLI reporting, where the capability information includes timing information associated with a timing between a CLI measurement resource and receipt of a trigger event that triggers the CLI measurement on the CLI measurement resource. The communications manager 1320 is capable of, configured to, or operable to support a means for outputting, to the UE, first control signaling that indicates a configuration for the CLI measurement and the CLI reporting based on the timing information and on a timing requirement for the timing between the CLI measurement resource and receipt of the trigger event. The communications manager 1320 is capable of, configured to, or operable to support a means for outputting, to the UE, second control signaling that is the trigger event that triggers the CLI measurement on the CLI measurement resource and that triggers transmission of a CLI report on a CLI report resource.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of timing requirement for CLI reporting as described herein, or the at least one processor 1335 and the at least one memory 1325 may be otherwise configured to, individually or collectively, perform or support such operations.

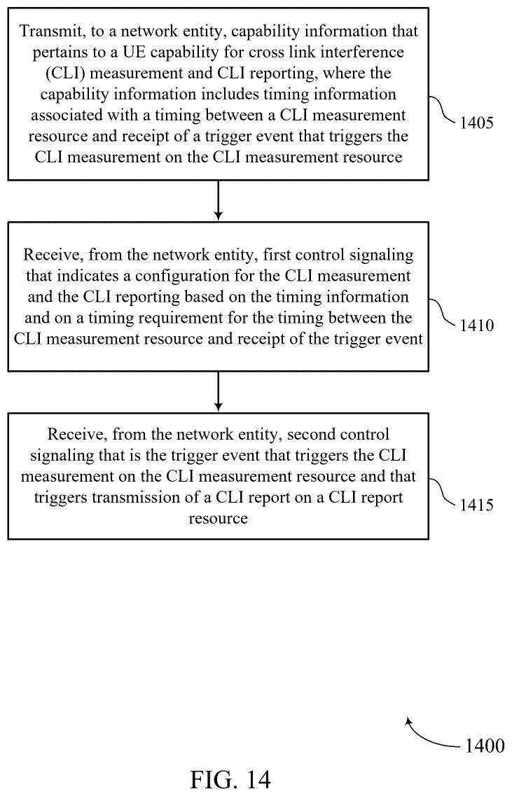

FIG. 14 shows a flowchart illustrating a method 1400 that supports a timing requirement for CLI reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The operations of 1405 may be performed in accordance with examples as disclosed herein. In some examples, aspects of the operations of 1405 may be performed by a capability information manager 825 as described with reference to FIG. 8.

At 1410, the method may include receiving, from the network entity, first control signaling that indicates a configuration for the CLI measurement and the CLI reporting based on the timing information and on a timing requirement for the timing between the CLI measurement resource and receipt of the trigger event. The operations of 1410 may be performed in accordance with examples as disclosed herein. In some examples, aspects of the operations of 1410 may be performed by a configuration manager 830 as described with reference to FIG. 8.

At 1415, the method may include receiving, from the network entity, second control signaling that is the trigger event that triggers the CLI measurement on the CLI measurement resource and that triggers transmission of a CLI report on a CLI report resource. The operations of 1415 may be performed in accordance with examples as disclosed herein. In some examples, aspects of the operations of 1415 may be performed by a trigger event manager 835 as described with reference to FIG. 8.

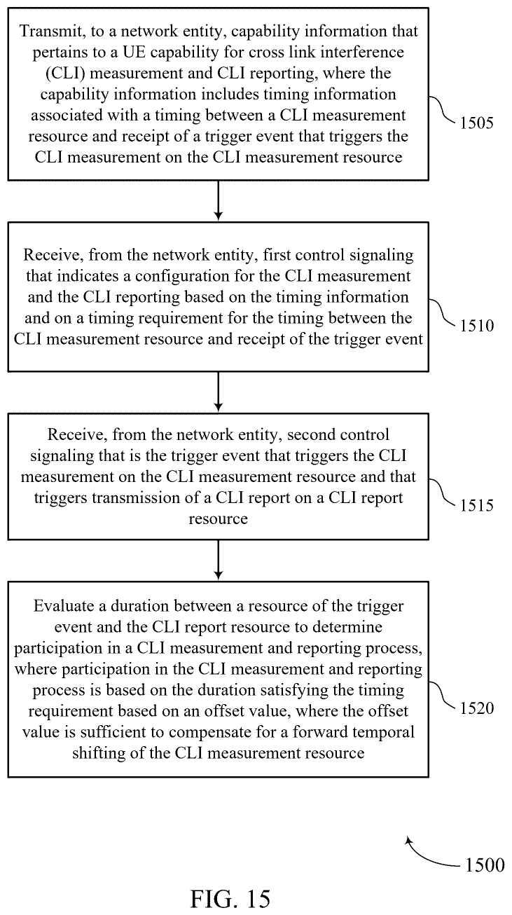

FIG. 15 shows a flowchart illustrating a method 1500 that supports a timing requirement for CLI reporting in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, to a network entity, capability information that pertains to a UE capability for CLI measurement and CLI reporting, where the capability information includes timing information associated with a timing between a CLI measurement resource and receipt of a trigger event that triggers the CLI measurement on the CLI measurement resource. The operations of 1505 may be performed in accordance with examples as disclosed herein. In some examples, aspects of the operations of 1505 may be performed by a capability information manager 825 as described with reference to FIG. 8.

At 1510, the method may include receiving, from the network entity, first control signaling that indicates a configuration for the CLI measurement and the CLI reporting based on the timing information and on a timing requirement for the timing between the CLI measurement resource and receipt of the trigger event. The operations of 1510 may be performed in accordance with examples as disclosed herein. In some examples, aspects of the operations of 1510 may be performed by a configuration manager 830 as described with reference to FIG. 8.

At 1515, the method may include receiving, from the network entity, second control signaling that is the trigger event that triggers the CLI measurement on the CLI measurement resource and that triggers transmission of a CLI report on a CLI report resource. The operations of 1515 may be performed in accordance with examples as disclosed herein. In some examples, aspects of the operations of 1515 may be performed by a trigger event manager 835 as described with reference to FIG. 8.

At 1520, the method may include evaluating a duration between a resource of the trigger event and the CLI report resource to determine participation in a CLI measurement and reporting process, where participation in the CLI measurement and reporting process is based on the duration satisfying the timing requirement based on an offset value, where the offset value is sufficient to compensate for a forward temporal shifting of the CLI measurement resource. The operations of 1520 may be performed in accordance with examples as disclosed herein. In some examples, aspects of the operations of 1520 may be performed by a CLI measurement and reporting process manager 840 as described with reference to FIG. 8.

The following provides an overview of aspects of the present disclosure:

Aspect 1: A method for wireless communication by a UE, comprising: transmitting, to a network entity, capability information that pertains to a UE capability for cross link interference (CLI) measurement and CLI reporting, wherein the capability information comprises timing information associated with a timing between a CLI measurement resource and receipt of a trigger event that triggers the CLI measurement on the CLI measurement resource; receiving, from the network entity, first control signaling that indicates a configuration for the CLI measurement and the CLI reporting based at least in part on the timing information and on a timing requirement for the timing between the CLI measurement resource and receipt of the trigger event; and receiving, from the network entity, second control signaling that is the trigger event that triggers the CLI measurement on the CLI measurement resource and that triggers transmission of a CLI report on a CLI report resource.

Aspect 2: The method of aspect 1, further comprising: evaluating a duration between a resource of the trigger event and the CLI report resource to determine participation in a CLI measurement and reporting process, wherein participation in the CLI measurement and reporting process is based at least in part on the duration satisfying the timing requirement based at least in part on an offset value, wherein the offset value is sufficient to compensate for a forward temporal shifting of the CLI measurement resource.

Aspect 3: The method of any of aspects 1 through 2, wherein the timing requirement is based at least in part on a first quantity of symbols between a symbol of the second control signaling and a symbol of the CLI report resource, a second quantity of symbols between a symbol of the CLI measurement resource and the symbol of the CLI report resource, or both.

Aspect 4: The method of aspect 3, further comprising: evaluating a duration between a resource of the trigger event and the CLI report resource to determine participation in a CLI measurement and reporting process, wherein participation in the CLI measurement and reporting process is based at least in part on the duration satisfying the first quantity of symbols or the second quantity of symbols and an offset value, wherein the offset value is sufficient to compensate for a forward temporal shifting of the CLI measurement resource.

Aspect 5: The method of any of aspects 1 through 2, wherein the timing requirement is based at least in part on a timing advance, the timing advance comprises a difference between a downlink reference timing and an uplink reference timing.

Aspect 6: The method of any of aspects 1 through 2, wherein the timing information comprises a CLI reporting timing, the CLI reporting timing indicates a quantity of symbols between a symbol of the CLI measurement resource and a symbol of the CLI report resource, the timing requirement is based at least in part on a first quantity of symbols between a symbol of the second control signaling and a symbol of the CLI report resource, a second quantity of symbols between a symbol of the CLI measurement resource and the symbol of the CLI report resource, or both, the second quantity is based at least in part on the CLI reporting timing.

Aspect 7: The method of any of aspects 1 through 2, wherein the timing information comprises a CLI beam switching timing, the CLI beam switching timing indicates a time between a resource of the second control signaling and the CLI measurement resource, the timing requirement is based at least in part on a first quantity of symbols between a symbol of the second control signaling and a symbol of the CLI report resource, or a second quantity of symbols between a symbol of the CLI measurement resource and the symbol of the CLI report resource, or both, the first quantity is based at least in part on the CLI beam switching timing.

Aspect 8: The method of aspect 1, wherein the second control signaling indicates a triggering offset, the triggering offset indicates the CLI measurement resource that satisfies the timing requirement.

Aspect 9: The method of aspect 8, wherein the triggering offset comprises a non-zero value.

Aspect 10: The method of aspect 1, wherein the second control signaling indicates a triggering offset, the triggering offset is based at least on a first quantity of symbols between a symbol of the second control signaling and a symbol of the CLI report resource, or a second quantity of symbols between a symbol of the CLI measurement resource and the symbol of the CLI report resource, or both, and a timing offset.

Aspect 11: The method of aspect 1, further comprising: evaluating a duration between a resource of the trigger event and the CLI report resource to determine participation in a CLI measurement and reporting process, wherein participation in the CLI measurement and reporting process is based at least in part on the duration satisfying the timing requirement; and refraining from transmitting the CLI report based at least in part on the duration not satisfying the timing requirement.

Aspect 12: The method of aspect 1, further comprising: evaluating a duration between a resource of the trigger event and the CLI report resource to determine participation in a CLI measurement and reporting process, wherein participation in the CLI measurement and reporting process is based at least in part on the duration satisfying the timing requirement; and transmitting a partial CLI report based at least in part on the duration not satisfying the timing requirement, wherein the partial CLI report comprises a quantity of CLI metrics less than a scheduled quantity of CLI measurements.

Aspect 13: The method of aspect 1, further comprising: evaluating a duration between a resource of the trigger event and the CLI report resource to determine participation in a CLI measurement and reporting process, wherein participation in the CLI measurement and reporting process is based at least in part on the duration satisfying the timing requirement; and transmitting the CLI report comprising one or more CLI metrics based at least in part on the duration satisfying the timing requirement.

Aspect 14: A method for wireless communication by a network entity, comprising: obtaining, from a UE, capability information that pertains to a UE capability for cross link interference (CLI) measurement and CLI reporting, wherein the capability information comprises timing information associated with a timing between a CLI measurement resource and receipt of a trigger event that triggers the CLI measurement on the CLI measurement resource; outputting, to the UE, first control signaling that indicates a configuration for the CLI measurement and the CLI reporting based at least in part on the timing information and on a timing requirement for the timing between the CLI measurement resource and receipt of the trigger event; and outputting, to the UE, second control signaling that is the trigger event that triggers the CLI measurement on the CLI measurement resource and that triggers transmission of a CLI report on a CLI report resource.

Aspect 15: The method of aspect 14, wherein the timing requirement is based at least in part on a first quantity of symbols between a symbol of the second control signaling and a symbol of the CLI report resource, a second quantity of symbols between a symbol of the CLI measurement resource and the symbol of the CLI report resource, or both.

Aspect 16: The method of aspect 14, wherein the timing requirement is based at least in part on a timing advance, the timing advance comprises a difference between a downlink reference timing and an uplink reference timing.

Aspect 17: The method of aspect 14, wherein the timing information comprises a CLI reporting timing, the CLI reporting timing indicates a quantity of symbols between a symbol of the CLI measurement resource and a symbol of the CLI report resource, the timing requirement is based at least in part on a first quantity of symbols between a symbol of the second control signaling and a symbol of the CLI report resource, a second quantity of symbols between a symbol of the CLI measurement resource and the symbol of the CLI report resource, or both, the second quantity is based at least in part on the CLI reporting timing.

Aspect 18: The method of aspect 14, wherein the timing information comprises a CLI beam switching timing, the CLI beam switching timing indicates a time between a resource of the second control signaling and the CLI measurement resource, the timing requirement is based at least in part on a first quantity of symbols between a symbol of the second control signaling and a symbol of the CLI report resource, a second quantity of symbols between a symbol of the CLI measurement resource and the symbol of the CLI report resource, or both, the first quantity is based at least in part on the CLI beam switching timing.

Aspect 19: The method of aspect 14, wherein the second control signaling indicates a triggering offset, the triggering offset indicates the CLI measurement resource that satisfies the timing requirement.

Aspect 20: The method of aspect 19, wherein the triggering offset comprises a non-zero value.

Aspect 21: The method of aspect 14, wherein the second control signaling indicates a triggering offset, the triggering offset is based at least on a first quantity of symbols between a symbol of the second control signaling and a symbol of the CLI report resource, a second quantity of symbols between a symbol of the CLI measurement resource and a symbol of the CLI report resource, or both and a timing offset.

Aspect 22: The method of any of aspects 14 through 21, further comprising: obtaining the CLI report comprising one or more CLI metrics.

Aspect 23: A UE for wireless communication, comprising one or more memories storing processor-executable code, and one or more processors coupled with the one or more memories and individually or collectively operable to execute the code to cause the UE to perform a method of any of aspects 1 through 13.

Aspect 24: A UE for wireless communication, comprising at least one means for performing a method of any of aspects 1 through 13.

Aspect 25: A non-transitory computer-readable medium storing code for wireless communication, the code comprising instructions executable by one or more processors to perform a method of any of aspects 1 through 13.

Aspect 26: A network entity for wireless communication, comprising one or more memories storing processor-executable code, and one or more processors coupled with the one or more memories and individually or collectively operable to execute the code to cause the network entity to perform a method of any of aspects 14 through 22.

Aspect 27: A network entity for wireless communication, comprising at least one means for performing a method of any of aspects 14 through 22.

Aspect 28: A non-transitory computer-readable medium storing code for wireless communication, the code comprising instructions executable by one or more processors to perform a method of any of aspects 14 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, capability information that pertains to a UE capability for cross link interference (CLI) measurement and CLI reporting, wherein the capability information comprises timing information associated with a timing between a CLI measurement resource and receipt of a trigger event that triggers the CLI measurement on the CLI measurement resource;
receive, from the network entity, first control signaling that indicates a configuration for the CLI measurement and the CLI reporting based at least in part on the timing information and on a timing requirement for the timing between the CLI measurement resource and receipt of the trigger event; and
receive, from the network entity, second control signaling that is the trigger event that triggers the CLI measurement on the CLI measurement resource and that triggers transmission of a CLI report on a CLI report resource.

2. The UE of claim 1, wherein the one or more processors are individually or collectively further operable to execute the code to cause the UE to:
evaluate a duration between a resource of the trigger event and the CLI report resource to determine participation in a CLI measurement and reporting process, wherein participation in the CLI measurement and reporting process is based at least in part on the duration satisfying the timing requirement based at least in part on an offset value, wherein the offset value is sufficient to compensate for a forward temporal shifting of the CLI measurement resource.

3. The UE of claim 1, wherein the timing requirement is based at least in part on a first quantity of symbols between a symbol of the second control signaling and a symbol of the CLI report resource, a second quantity of symbols between a symbol of the CLI measurement resource and the symbol of the CLI report resource, or both.

4. The UE of claim 3, wherein the one or more processors are individually or collectively further operable to execute the code to cause the UE to:
evaluate a duration between a resource of the trigger event and the CLI report resource to determine participation in a CLI measurement and reporting process, wherein participation in the CLI measurement and reporting process is based at least in part on the duration satisfying the first quantity of symbols or the second quantity of symbols and an offset value, wherein the offset value is sufficient to compensate for a forward temporal shifting of the CLI measurement resource.

5. The UE of claim 1, wherein:
the timing requirement is based at least in part on a timing advance, and
the timing advance comprises a difference between a downlink reference timing and an uplink reference timing.

6. The UE of claim 1, wherein:
the timing information comprises a CLI reporting timing,
the CLI reporting timing indicates a quantity of symbols between a symbol of the CLI measurement resource and a symbol of the CLI report resource,
the timing requirement is based at least in part on a first quantity of symbols between a symbol of the second control signaling and a symbol of the CLI report resource, a second quantity of symbols between a symbol of the CLI measurement resource and the symbol of the CLI report resource, or both, and
the second quantity is based at least in part on the CLI reporting timing.

7. The UE of claim 1, wherein:
the timing information comprises a CLI beam switching timing,
the CLI beam switching timing indicates a time between a resource of the second control signaling and the CLI measurement resource,
the timing requirement is based at least in part on a first quantity of symbols between a symbol of the second control signaling and a symbol of the CLI report resource, or a second quantity of symbols between a symbol of the CLI measurement resource and the symbol of the CLI report resource, or both, and
the first quantity is based at least in part on the CLI beam switching timing.

8. The UE of claim 1, wherein:
the second control signaling indicates a triggering offset, and
the triggering offset indicates the CLI measurement resource that satisfies the timing requirement.

9. The UE of claim 8, wherein the triggering offset comprises a non-zero value.

10. The UE of claim 1, wherein:
the second control signaling indicates a triggering offset, and
the triggering offset is based at least on a first quantity of symbols between a symbol of the second control signaling and a symbol of the CLI report resource, or a second quantity of symbols between a symbol of the CLI measurement resource and the symbol of the CLI report resource, or both, and a timing offset.

11. The UE of claim 1, wherein the one or more processors are individually or collectively further operable to execute the code to cause the UE to:
evaluate a duration between a resource of the trigger event and the CLI report resource to determine participation in a CLI measurement and reporting process, wherein participation in the CLI measurement and reporting process is based at least in part on the duration satisfying the timing requirement; and
refrain from transmitting the CLI report based at least in part on the duration not satisfying the timing requirement.

12. The UE of claim 1, wherein the one or more processors are individually or collectively further operable to execute the code to cause the UE to:
evaluate a duration between a resource of the trigger event and the CLI report resource to determine participation in a CLI measurement and reporting process, wherein participation in the CLI measurement and reporting process is based at least in part on the duration satisfying the timing requirement; and
transmit a partial CLI report based at least in part on the duration not satisfying the timing requirement, wherein the partial CLI report comprises a quantity of CLI metrics less than a scheduled quantity of CLI measurements.

13. The UE of claim 1, wherein the one or more processors are individually or collectively further operable to execute the code to cause the UE to:
evaluate a duration between a resource of the trigger event and the CLI report resource to determine participation in a CLI measurement and reporting process, wherein participation in the CLI measurement and reporting process is based at least in part on the duration satisfying the timing requirement; and
transmit the CLI report comprising one or more CLI metrics based at least in part on the duration satisfying the timing requirement.

14. A method for wireless communication by a user equipment (UE), comprising:
transmitting, to a network entity, capability information that pertains to a UE capability for cross link interference (CLI) measurement and CLI reporting, wherein the capability information comprises timing information associated with a timing between a CLI measurement resource and receipt of a trigger event that triggers the CLI measurement on the CLI measurement resource;
receiving, from the network entity, first control signaling that indicates a configuration for the CLI measurement and the CLI reporting based at least in part on the timing information and on a timing requirement for the timing between the CLI measurement resource and receipt of the trigger event; and
receiving, from the network entity, second control signaling that is the trigger event that triggers the CLI measurement on the CLI measurement resource and that triggers transmission of a CLI report on a CLI report resource.

15. The method of claim 14, further comprising:
evaluating a duration between a resource of the trigger event and the CLI report resource to determine participation in a CLI measurement and reporting process, wherein participation in the CLI measurement and reporting process is based at least in part on the duration satisfying the timing requirement based at least in part on an offset value, wherein the offset value is sufficient to compensate for a forward temporal shifting of the CLI measurement resource.

16. The method of claim 14, wherein the timing requirement is based at least in part on a first quantity of symbols between a symbol of the second control signaling and a symbol of the CLI report resource, a second quantity of symbols between a symbol of the CLI measurement resource and the symbol of the CLI report resource, or both.

17. The method of claim 16, further comprising:
evaluating a duration between a resource of the trigger event and the CLI report resource to determine participation in a CLI measurement and reporting process, wherein participation in the CLI measurement and reporting process is based at least in part on the duration satisfying the first quantity of symbols or the second quantity of symbols and an offset value, wherein the offset value is sufficient to compensate for a forward temporal shifting of the CLI measurement resource.

18. The method of claim 14, wherein:
the timing information comprises a CLI reporting timing,
the CLI reporting timing indicates a quantity of symbols between a symbol of the CLI measurement resource and a symbol of the CLI report resource,
the timing requirement is based at least in part on a first quantity of symbols between a symbol of the second control signaling and a symbol of the CLI report resource, a second quantity of symbols between a symbol of the CLI measurement resource and the symbol of the CLI report resource, or both, and
the second quantity is based at least in part on the CLI reporting timing.

19. The method of claim 14, wherein:
the timing information comprises a CLI beam switching timing,
the CLI beam switching timing indicates a time between a resource of the second control signaling and the CLI measurement resource,
the timing requirement is based at least in part on a first quantity of symbols between a symbol of the second control signaling and a symbol of the CLI report resource, or a second quantity of symbols between a symbol of the CLI measurement resource and the symbol of the CLI report resource, or both, and
the first quantity is based at least in part on the CLI beam switching timing.

20. A non-transitory computer-readable medium storing code for wireless communication, the code comprising instructions executable by one or more processors to:
transmit, to a network entity, capability information that pertains to a UE capability for cross link interference (CLI) measurement and CLI reporting, wherein the capability information comprises timing information associated with a timing between a CLI measurement resource and receipt of a trigger event that triggers the CLI measurement on the CLI measurement resource;
receive, from the network entity, first control signaling that indicates a configuration for the CLI measurement and the CLI reporting based at least in part on the timing information and on a timing requirement for the timing between the CLI measurement resource and receipt of the trigger event; and
receive, from the network entity, second control signaling that is the trigger event that triggers the CLI measurement on the CLI measurement resource and that triggers transmission of a CLI report on a CLI report resource.
